(19) United States
(12) Patent Application Publication
(10) Pub. No.: US 2024/0174111 A1
(43) Pub. Date: May 30, 2024

(54) METHOD FOR OPERATING A CHARGING STATION FOR ELECTRIC VEHICLES AND CHARGING STATION FOR CARRYING OUT SUCH A METHOD

(71) Applicant: ads-tec Energy GmbH, Nürtingen (DE)

(72) Inventor: Korbinian HÖRFURTER, Haag (DE)

(21) Appl. No.: 18/511,162

(22) Filed: Nov. 16, 2023

(30) Foreign Application Priority Data
Nov. 24, 2022 (DE) 102022131172.4

(51) Int. Cl. B60L 53/64; B60L 53/66

(52) U.S. Cl. CPC B60L 53/64; B60L 53/665; B60L 2240/80; B60L 2250/20

(57) ABSTRACT

The invention relates to a method for operating a charging station (1) having a digital electricity meter (3) for electric vehicles, whereby a current time of day is received by the charging station (1) as a digital time stamp (21), whereby a charging process is carried out by means of the charging station, whereby
the charging process is initiated, whereby
after the initiation of the charging process, a meter time of day (23) of the digital electricity meter (3) is adjusted based on the digital time stamp (21), whereby
an energy transfer to an electric vehicle is carried out, whereby
a charging process data set (25) is created by using the meter time of day (23), whereby
the charging process is ended.

The invention relates to a method for operating a charging station for electric vehicles and a charging station, which is configured to be operated according to such a method.

A method and a device for assigning an amount of energy transferred from a charging station to a user is disclosed from the European patent specification EP 2 531 368 B1. In order to ensure that the transferred amount of energy is used only for a user, who is responsible for this, at least one electricity meter reading, which represents the amount of energy obtained from the charging station by an electric vehicle, is detected, A user identification is furthermore detected, and a data packet, comprising at least the electricity meter reading and the user identification is created. A unique description of the data packet is additionally created, and at least the data packet and the description are transmitted to the electric vehicle and/or a billing center. A disadvantage of this is that a billing, which conforms to calibration law, of the transferred amount of energy cannot be ensured.

The invention is thus based on the object of creating a method for operating a charging station for electric vehicles and a charging station, which is configured to be operated according to such a method, whereby the mentioned disadvantages are at least partially eliminated, preferably avoided.

The object is solved in that the present technical teaching is provided, in particular the teaching of the independent claims as well as of the embodiments disclosed in the dependent claims and the description.

The object is solved in particular in that a method for operating a charging station for electric vehicles comprising a digital electricity meter is created. A current time is thereby received as a digital time stamp, in particular during an operation of the charging station. A charging process is furthermore carried out by means of the charging station, in particular during the operation of the charging station. The charging process is initiated, whereby, after the initiation of the charging process, a meter time of the digital electricity meter is adjusted based on the digital time stamp. An energy transfer to an electric vehicle, which is in particular connected to the charging station in a wired or wireless manner, is furthermore carried out in particular after the initiation of the charging process. A charging process data set is furthermore created, in particular after ending the energy transfer, by using the meter time. The charging process is ended subsequently. Advantageously, it is possible therewith, in particular by setting the meter time, to ensure a billing, which conforms to calibration law, of a transferred amount of energy. Advantageously, the meter time is updated by adjusting or setting the meter time, in particular before the start of the energy transfer, and clock drifts, which may be present, between a detection of a time of day used to create the digital time stamp and a detection of the meter time of day are at least reduced, in particular eliminated.

In the context of the present technical teaching, a clock drift is in particular a deviation of a time of day compared to a reference time. The deviation can be constant in time or variable in time—in particular steadily rising or steadily falling. The clock drift in particular consists of a constant deviation—in particular a constant value—and a clock rate—in particular a temporally variable value.

In one embodiment, the current time of day is received as the digital time stamp during or after the initiation of the charging process. Alternatively or additionally, in particular additionally, the current time of day is received as the digital time stamp before a start of the energy transfer.

The meter time of day of the digital electricity meter is in particular adjusted prior to the energy transfer. The meter time of day of the digital electricity meter is in particular not adjusted during the energy transfer.

In one embodiment, the digital time stamp is obtained as the current time of day from a time server, in particular a time server of the German National Metrology Institute in Braunschweig.

The current time of day is in particular received as a signed digital time stamp. It is thus advantageously possible to verify a sender of the digital time stamp, in particular the time server of the German National Metrology Institute in Braunschweig.

The digital electricity meter is in particular configured to measure the amount of energy transferred during the energy transfer. An initial meter reading of the digital electricity meter is in particular detected before the beginning of the energy transfer, and a final meter reading of the digital electricity meter is detected after ending the energy transfer, and the transferred amount of energy is determined therefrom.

The current time of day is in particular received in an encrypted manner as the digital time stamp, in particular during the operation of the charging station. The encrypted digital time stamp is furthermore preferably decrypted, whereby a decrypted digital time stamp is obtained.

The meter time of day in particular runs at a meter time of day rate speed independently of a clock of the time server, in particular of the time server of the German National Metrology Institute in Braunschweig. By adjusting the meter time of day, a jump in the current value of the meter time of day is thus in particular created at least as a general rule.

In one design, the charging process data set is created by means of the digital electricity meter, in particular by the digital electricity meter.

In one embodiment, a QR code with a link to the charging process data set is created and is in particular transmitted to a user of the charging station or is displayed to the user.

According to a further development of the invention, it is provided that, based on the digital time stamp, a charging station time stamp is created, whereby the charging station time stamp is transmitted to the digital electricity meter. The meter time of day is adjusted in that the charging station time stamp is set as a current value of the meter time of day. It is thus advantageously possible to adjust a charging station time of day on the basis of the digital time stamp and to synchronize the charging station time of day and the meter time of day.

The charging station time stamp is in particular created on the basis of the decrypted digital time stamp. The charging station time stamp is further in particular transmitted to the digital electricity meter in an unencrypted manner and is set as the current value of the meter time of day.

In one embodiment, a charging station time of day of the charging station is adjusted on the basis of the digital time stamp, in particular in that the digital time stamp is set as a current value of the charging station time of day. The charging station time of day in particular runs at a charging station time of day rate speed independently of the digital electricity meter and/or of the meter time of day and in particular independently of the clock of the time server, in particular of the time server of the German National Metrology Institute in Braunschweig. By adjusting the charging station time of day, a jump in the current value of the charging station time of day is in particular created at least as a general rule. The charging station time stamp is furthermore created on the basis of the charging station time of day. An adjusting of the charging station time of day and the adjusting of the meter time of day are thus advantageously decoupled from one another, whereby in particular the clock drift between a detection of a time of day used to adjust the digital time stamp and a detection of the meter time of day is at least reduced, in particular eliminated. A time period of any length can generally pass between the adjusting of the charging station time of day and the creation of the charging station time stamp on the basis of the charging station time of day; the clock drift between the detection of the meter time of day and the time server, however, is smaller, the shorter the time period between the adjustment of the charging station time of day and the creation of the charging station time stamp.

In an alternative design, a charging station time stamp is created—in particular directly—on the basis of the digital time stamp, whereby the charging station time stamp is transmitted to the digital electricity meter. The meter time of day is adjusted in that the charging station time stamp is set as a current value of the meter time of day. Advantageously, it is possible therewith to adjust the meter time of day without adjusting the charging station time of day.

According to a further development of the invention, it is provided that the charging process data set is digitally signed by the digital electricity meter. Advantageously, it is possible therewith to assign the charging process data set to the charging station and in particular to the digital electricity meter uniquely and in particular in a tamper-proof manner.

In one design, a digital signature is stored in the charging process data set, in particular as OCTET string, in particular in the DER format.

In the context of the present technical teaching, an OCTET is in particular an ordered list, in particular a tuple, of eight bits. An OCTET string is thus furthermore a character string of a plurality of OCTETs.

In the context of the present technical teaching, the DER format is in particular a binary format for data structures, which are described in ASN.1. ASN.1 is thereby a description language for defining data structures as well as determinations for implementing data structures and elements into a uniform network format.

According to a further development of the invention, it is provided that at least one time of day, selected from the meter time of day and the charging station time of day, is adjusted no later than a predetermined tolerance time period after the receipt of the current time of day as the digital time stamp or after the creation of the charging station time stamp. It is thus advantageously ensured that, except for the predetermined tolerance time period, the meter time of day is adjusted exactly in particular with respect to the digital time stamp.

In one design—in particular when the charging station time of day is adjusted on the basis of the digital time stamp and the charging station time stamp is created on the basis of the charging station time of day—the meter time of day is adjusted no later than a first predetermined tolerance time period after the receipt of the current time of day as the digital time stamp. Alternatively or additionally, the meter time of day is adjusted no later than a second predetermined tolerance time period after the creation of the charging station time stamp, in particular in that the charging station time stamp is set as a current value of the meter time of day. Alternatively or additionally, the charging station time of day is adjusted no later than a third predetermined tolerance time period after the receipt of the current time of day as the digital time stamp.

In an alternative design—in particular when the charging station time stamp is created directly on the basis of the digital time stamp—the charging station time stamp is set no later than the predetermined tolerance time period after the receipt of the current time of day as the digital time stamp as the current value of the meter time of day.

According to a further development of the invention, it is provided that 5 seconds, preferably 4 seconds, preferably 3 seconds, preferably 2 seconds, preferably 1 second, particularly preferably 0.5 seconds, is used as the predetermined tolerance time period.

In particular, 5 seconds, preferably 4 seconds, preferably 3 seconds, preferably 2 seconds, preferably 1 second, particularly preferably 0.5 seconds, is used as at least one tolerance time period, selected from the first predetermined tolerance time period, of the second predetermined tolerance time period, and the third predetermined tolerance time period. Particularly preferably, 5 seconds, preferably 4 seconds, preferably 3 seconds, preferably 2 seconds, preferably 1 second, particularly preferably 0.5 seconds, are used as the second predetermined tolerance time period and the third predetermined tolerance time period in each case.

According to a further development of the invention, it is provided that, based on the digital time stamp, the meter time of day of the digital electricity meter is adjusted before the energy transfer is started. Alternatively or additionally, the energy transfer is activated only when the meter time of day has been adjusted, based on the digital time stamp. It is advantageously ensured therewith that the meter time of day is not adjusted during the energy transfer and that a faulty meter time of day is thus used for the charging process data set.

The energy transfer is in particular only activated when the charging station time stamp has been set as the current value of the meter time of day.

According to a further development of the invention, it is provided that a user of the charging station is identified during the initiation of the charging process, whereby a unique user identification is detected and the unique user identification is transmitted to the digital electricity meter.

According to a further development of the invention, it is provided that a charging point of the charging station is selected during the initiation of the charging process.

The charging point of the charging station is in particular selected before the user of the charging station is identified.

The charging point of the charging station is in particular selected by the user, in particular by means of an operating device.

According to a further development of the invention, it is provided that a payment type is selected during the initiation of the charging process.

The payment type is in particular selected before the user of the charging station is identified.

The payment type is in particular selected by the user, in particular by means of an operating device.

According to a further development of the invention, it is provided that the user of the charging station is identified during the initiation of the charging station on the basis of an RFID chip. Alternatively or additionally, the user of the charging station is identified on the basis of a credit card. Alternatively or additionally, the user of the charging station is identified on the basis of a smartphone. Alternatively or additionally, the user of the charging station is identified on the basis of a charge card. Alternatively or additionally, the user of the charging station is identified on the basis of a digital service recipient identification

In one embodiment, the user of the charging station is identified on the basis of the RFID chip. An identification number of the RFID chip is thereby used as the unique user identification.

In an alternative design, in particular in the case of an ad-hoc charging process, the user of the charging station is identified on the basis of the credit card. A system trace audit number—a so-called STAN—is used thereby as the unique user identification in combination with an identification number of the charging station, in particular an identification number of a payment module of the charging station.

In an alternative design, the user of the charging station is identified on the basis of the smart phone, in particular via a smartphone application. The unique user identification is thereby transmitted to the charging station in particular by a data center, in particular a charging station data center, or a third-party data center, or directly by the smartphone.

In one embodiment, the unique user identification is in particular stored in the smartphone, in particular in the smartphone application, and is received by the charging station to identify the user. Alternatively, the unique user identification is created in the smartphone, in particular in the smartphone application, in particular ad hoc, and is received by the charging station to identify the user.

In the context of the present technical teaching, a charging station billing venter is in particular a data center of an operator of the charging station. A release of the charging process, a release of the energy transfer, a billing and documentation of the charging processes, and a maintenance of the charging station in particular takes place via the charging station data center.

In the context of the present technical teaching, a third-party data center is in particular a data center of a third-party operator, who differs from the operator of the charging station. A transmission of the unique user identification to the charging station in particular takes place via the third-party data center.

In an alternative design, in particular in the case of a plug-and-charge charging process, the user of the charging station is identified on the basis of the digital service recipient identification. The digital service recipient identification is thereby used as the unique user identification. The digital service recipient identification is in particular stored in the electric vehicle and is transmitted to the charging station. The digital service recipient identification is transmitted to the charging station in particular via a charging cable when the charging cable is connected to the electric vehicle.

According to a further development of the invention, it is provided that the unique user identification is transmitted to the charging station data center during the initiation of the charging process, whereby the charging station data center releases the energy transfer at the charging station on the basis of the unique user identification.

According to a further development of the invention, it is provided that the charging process data set comprises at least one piece of information, which is selected from a group, consisting of: The unique user identification, an amount of energy released by the charging station, in particular transferred to the electric vehicle, a start time and a time period of the charging process, the start time and an end time of the charging process, a unique electricity meter identification of the digital electricity meter, and a combination of at least two pieces of this information.

The charging process data set is preferably created as OCMF file.

In the context of the present technical teaching, and OCMF file is a file, which digitally records at least one event or feature characterizing the charging process, in particular a plurality of features characterizing the charging process, in the open charge metering format (OCMF).

In one design, the OCMF file has information about the digital electricity meter, meta information about the energy transfer, information about a start of the energy transfer, information about an end of the energy transfer, information about the signature, and the signature.

The information about the digital electricity meter in particular has an OCMF format version, a device type, the unique electricity meter identification, in particular a serial number, a device version, a manufacturer's designation, and a firmware version.

The meta information about the energy transfer in particular has information as to whether the unique user identification was determined, a trust status of the unique user identification, a type of a determination of the unique user identification, information about the condition and/or origin of the unique user identification, the unique user identification, a type of an encoding of an identifier of the charging station, in particular of a charging point of the charging station, and a charging infrastructure identifier of the charging station, in particular of the charging point.

The information about the start and about the end of the energy transfer in particular has a time stamp, information about start or end of the energy transfer, a meter reading of the digital electricity meter, an interpretation of the meter reading, a unit of the digital electricity meter, a type of the current, in particular direct current or alternating current, information about an error message, and a status of the energy transfer.

In the context of the present teaching, the interpretation of the meter reading in particular comprises information as to whether the meter reading is stored in the charging process data set as temporally local or temporally global meter reading. A temporally global meter reading is in particular a meter reading, which continuously counts an amount of energy since the production of the digital meter reader. A temporally local meter reading is in particular a meter reading, which is set to a predetermined meter value, in particular zero, at the start of the charging process.

The information about the signature in particular has information about a cryptographic method of the signature.

According to a further development of the invention, it is provided that the in particular signed charging process data set is transmitted to the charging station data center.

The in particular signed charging process data set is in particular stored in the charging station data center.

In one design, in particular in the case of an ad-hoc charging process, the in particular signed charging process data set is transmitted to the user in an account overview and/or credit card statement.

According to a further development of the invention, it is provided that a startup process is carried out immediately after turning on the charging station. The current time of day is received by the charging station as the digital time stamp during the startup process. The meter time of day is furthermore adjusted based on the digital time stamp.

In one design, the charging station time of day of the charging station is adjusted during the startup process on the basis of the digital time stamp, in particular in that the digital time stamp is set as a current value of the charging station time of day. By adjusting the charging station time of day, a jump in the current value of the meter time of day is in particular created at least as a general rule. The charging station time stamp is furthermore created on the basis of the charging station time of day, whereby the charging station time stamp is transmitted to the digital electricity meter. The meter time of day is adjusted subsequently in that the charging station time stamp is set as a current value of the meter time of day.

In an alternative design, the charging station time stamp is created during the startup process—in particular directly—on the basis of the digital time stamp, whereby the charging station time stamp is transmitted to the digital electricity meter. The meter time of day is adjusted subsequently in that the charging station time stamp is set as a current value of the meter time of day.

The meter time of day is in particular adjusted no later than the first predetermined tolerance time period after the receipt of the current time of day as the digital time stamp. Alternatively or additionally, the meter time of day is adjusted no later than the second predetermined tolerance time period after the creation of the charging station time stamp, in particular in that the charging station time stamp is set as a current value of the meter time of day. Alternative or additionally, the charging station time of day is adjusted no later than the third predetermined tolerance time period after the receipt of the current time of day as the digital time stamp.

In one design, a startup program, in particular a bootloader, preferably the program U-Boot, is initially run during the startup process. An operating system of the charging station, in particular a Linux distribution, preferably OpenWRT, is subsequently started. The current time of day is subsequently received by the charging station as the digital time stamp and the charging station time of day is adjusted on the basis of the digital time stamp. A control program of the charging station is furthermore started. The charging station time stamp is then set as a current value of the meter time of day, and the charging station is released, so that a user can interact with the charging station and a charging process can be carried out. It is additionally verified, preferably after the start of the control program of the charging station, whether a charging process has not yet been ended in the digital electricity meter, in particular is still active—in the error case of the charging station. If no, the meter time of day is adjusted. If yes, the charging process dataset for the charging process, which has not been ended yet, is created by using the meter time of day, which has not been newly adjusted yet, the charging process is ended, and the meter time of day is subsequently adjusted.

According to a further development of the invention, it is provided that an updating process is carried out when at least 24 hours, preferably at least 12 hours, preferably at least 10 hours, preferably at least 5 hours, preferably at least 2 hours, preferably at least 1 hour, have passed since a previous adjustment of the meter time of day. The current time of day is received as the digital time stamp during the updating process by the charging station. The meter time of day is furthermore adjusted based on the digital time stamp.

In one design, the charging station time of day of the charging station is adjusted during the updating process on the basis of the digital time stamp, in particular in that the digital time stamp is set as a current value of the charging station time of day. By adjusting the charging station time of day, a jump in the current value of the meter time of day is thus in particular created at least as a general rule. The charging station time stamp is furthermore created on the basis of the charging station time of day, whereby the charging station time stamp is transmitted to the digital electricity meter. The meter time of day is adjusted subsequently in that the charging station time stamp is set as a current value of the meter time of day.

In an alternative design, the charging station time stamp is created during the updating process on the basis of the digital time stamp, whereby the charging station time stamp is transmitted to the digital electricity meter. The meter time of day is adjusted subsequently in that the charging station time stamp is set as a current value of the meter time of day.

The meter time of day is adjusted no later than the first predetermined tolerance time period after the receipt of the current time of day as the digital time stamp. Alternatively or additionally, the meter time of day is adjusted no later than the second predetermined tolerance time period after the creation of the charging station time stamp, in particular in that the charging station time stamp is set as a current value of the meter time of day. Alternatively or additionally, the charging station time of day is adjusted no later than the third predetermined tolerance time period after the receipt of the current time of day as the digital time stamp.

The updating process is preferably not carried out when a charging process is carried out simultaneously. The updating process and the charging process are in particular not carried out simultaneously. The updating process is in particular blocked from being carried out when the charging process is carried out. It is in particular not possible to carry out the updating process while carrying out the charging process.

In one design, the charging process can only be started when the last adjustment of the meter time of day was not more than 24 hours ago. Advantageously, the updating process ensures therewith that the meter time of day is set anew at least every 24 hours and a charging process can thus be started at any time.

The object is also solved in that a charging station comprising a digital electricity meter is created. The charging station is thereby configured to be operated according to a method according to the invention or according to a method according to one or several of the above-described embodiments. In particular the advantages, which have already been described in connection with the method for operating the charging station, follow in connection with the charging station.

In one design, the charging station has an operating device comprising a display means and an RFID reading device. The display means is in particular configured for the user guidance, whereby instructions to a user of the charging station are displayed on the display means. In addition, the display means is preferably configured to display a QR code with a link to a charging process data set. The RFID reading device is in particular configured to read an RFID chip, so that the user of the charging station can be identified on the basis of the RFID chip by means of the RFID reading device. Alternatively or additionally, the charging station has a communication module, whereby the communication module is preferably formed as firewall router means. The communication module is in particular configured to receive a current time of day as an in particular encrypted digital time stamp during an operation of the charging station, and/or to transmit a unique user identification to a charging station data center, and/or to receive a release of an energy transfer from the charging station data center, in particular based on the unique user identification, and/or to transmit the charging process data set to the charging station data center. Alternatively or additionally, the charging station has a payment module, whereby the payment module is in particular configured to read a credit card, so that the user of the charging station can be identified on the basis of the credit card by means of the payment module, in particular to carry out a so-called ad-hoc charging process.

In electrical engineering, any, in particular stationary or mobile device or electrical installation, which serves the purpose of supplying energy to mobile accumulator-operated equipment, machines, or motor vehicles, by means of a simple setting or plugging in, without inevitably having to remove the energy storage—for instance, the traction battery of an electric vehicle—is referred to as charging station. Charging stations for electric vehicles are sometimes also referred to as “electricity charging stations” and can comprise several charging points. In particular direct current quick charging systems (high performance charging systems or high power charging systems, HPC systems) such as the so-called combined charging system (CCS), which is common in Europe, are known here. During the generic direct current charging, direct current from the charging station is fed directly into the battery of the vehicle and is, for this purpose, provided to, e.g., solar charging stations by means of a powerful rectifier, preferably of the charging station, from the power supply or by means of large buffer accumulators. A battery management system, which communicates directly or indirectly with the charging station, in order to adapt the current and voltage or to end the process when reaching a predetermined capacity limit, is located in the vehicle. Power electronics are thereby typically located in the charging station. Due to the fact that the DC connections of the charging station are connected directly—without detour via an AC/DC converter of the vehicle—to corresponding terminals of the traction battery, high charging currents can be transferred with little loss, which provides for short charging times.

In one embodiment, the charging station is formed as a charging column. The charging station in particular has at least one charging point, in particular exactly one charging point or exactly two charging points. A digital electricity meter is in particular assigned to each charging point.

The charging station is in particular formed as quick charging station. In one embodiment, the charging station is formed as battery-supported charging station, in particular as battery-supported quick charging station.

The invention will be described in more detail below on the basis of the drawing, in which:

FIG. 1 shows a schematic illustration of a first exemplary embodiment of a charging station,

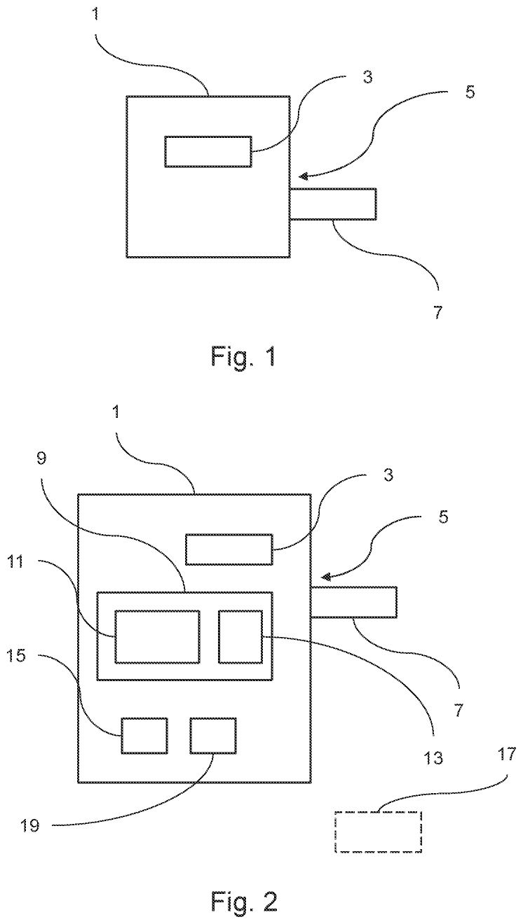

FIG. 2 shows a schematic illustration of a second exemplary embodiment of the charging station,

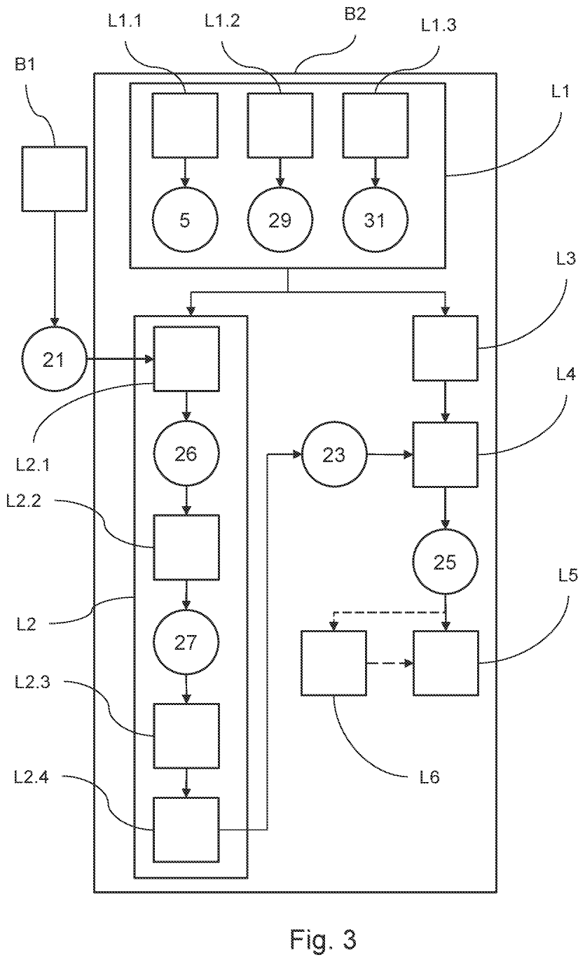

FIG. 3 shows a flowchart of a first exemplary embodiment of a method for operating the charging station,

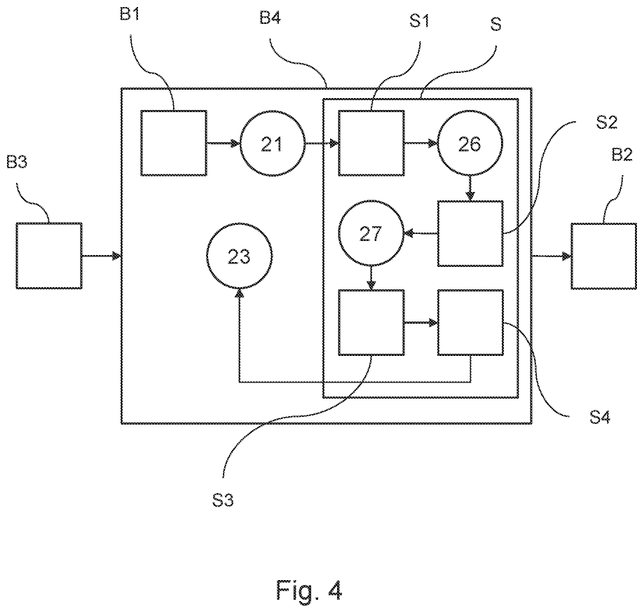

FIG. 4 shows a flowchart of a second exemplary embodiment of the method for operating the charging station,

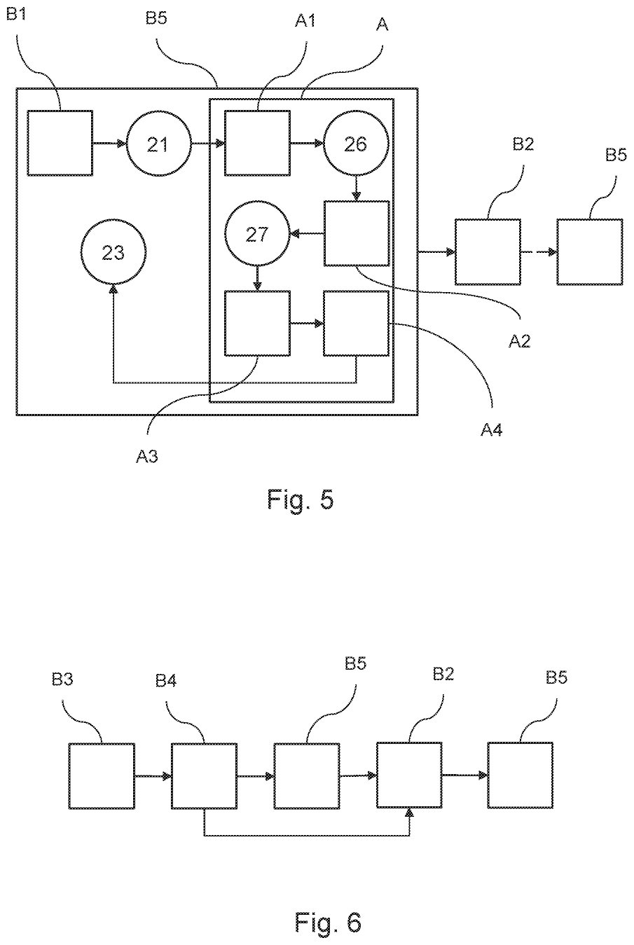

FIG. 5 shows a flowchart of a third exemplary embodiment of the method for operating the charging station, and

FIG. 6 shows a flowchart of a fourth exemplary embodiment of the method for operating the charging station.

FIG. 1 shows a schematic illustration of a first exemplary embodiment of a charging station 1 comprising a digital electricity meter 3. The charging station 1 additionally has a charging point 5 comprising a charging cable 7. The digital electricity meter 3 is in particular assigned to the charging point 5 and thus also to the charging cable 7, so that an amount of energy, which is transferred by means of the charging point 5, can be measured by means of the digital electricity meter 3.

The charging station 1 is in particular configured to be operated by means of a method for operating the charging station 1. Exemplary embodiments of the method for operating the charging station 1 will be described in detail on the basis of FIGS. 3 to 6.

FIG. 2 shows a schematic illustration of a second exemplary embodiment of the charging station 1 comprising the digital electricity meter 3.

Identical and functionally identical elements are provided with the same reference numerals in all figures, so that reference is made to the preceding description in this respect.

The charging station 1 additionally has an operating device 9 comprising a display means 11 and an RFID reading device 13. The display means 11 is in particular configured for the user guidance, whereby instructions to a user of the charging station 1 are displayed on the display means 11. In addition, the display means 11 is preferably configured to display a QR code comprising a link to a charging process data set 25. The RFID reading device 13 is in particular configured to read an RFID chip, so that the user of the charging station 1 is identified on the basis of the RFID chip by means of the RFID reading device 13. The charging station 1 furthermore has a communication module 15, whereby the communication module 15 is preferably formed as firewall router means. The communication module 15 is in particular configured to receive a current time of day as an in particular encrypted digital time stamp 21 during an operation of the charging station 1, and/or to transmit a unique user identification 31 to a charging station data center 17, and/or to receive a release of an energy transfer from the charging station data center 17, in particular based on the unique user identification 31, and/or to transmit a charging process data set 25 to the charging station data center 17. Alternatively or additionally, the charging station 1 has a payment module 19, whereby the payment module 19 is in particular configured to read a credit card, so that the user of the charging station 1 is identified on the basis of the credit card by means of the payment module 19, in particular to carry out a so-called ad-hoc charging process.

The digital electricity meter 3, the operating device 9, in particular the display means 11, and the RFID reading device 13, the communication module 15, and the payment module 19 are in particular operatively connected to one another in a way, which is not illustrated explicitly here.

The charging station 1 is in particular configured to be operated by means of a method for operating the charging station 1. Exemplary embodiments of the method for operating the charging station 1 will be described in detail on the basis of FIGS. 3 to 6.

FIG. 3 shows a flowchart of an exemplary embodiment of a method for operating the charging station 1.

In a first operating step B1, a current time of day is received by the charging station 1 as a digital time stamp 21. The current time of day is in particular received in an encrypted manner as a digital time stamp 21. The current time of day is particularly preferably received as a signed digital time stamp 21.

In a second operating step B2, a charging process is carried out by means of the charging station 1.

During the second operating step B2, the charging process is initiated in a first charging step L1.

In a first first charging step L1.1, the charging point 5 of the charging station 1 is preferably selected, in particular by a user, in particular by means of the operating device 9.

In a second first charging step L1.2, a payment type 29 is preferably selected, in particular by the user, in particular by means of the operating device 9.

In a third first charging step L1.3, the user of the charging station 1 is preferably identified, whereby a unique user identification 31 is detected, whereby the unique user identification 31 is transmitted to the digital electricity meter 3.

In addition, in the third first charging step L1.3, the unique user identification 31 is particularly preferably transmitted to the charging station data center 17, whereby the charging station data center 17 releases the energy transfer at the charging station 1 based on the unique user identification 31.

In the third first charging step L1.3, the user of the charging station 1 is preferably identified on the basis of the RFID chip, and/or the credit card, and/or a smartphone, and/or a charge card, and/or a digital service receiver identification.

In a second charging step L2, the meter time of day 23 is furthermore adjusted after the initiation of the charging process based on the digital time stamp 21.

In a first second charging step L2.1., a charging station time of day 26 is preferably adjusted on the basis of the digital time stamp 21, in particular in that the digital time stamp 21 is set as a current value of the charging station time of day 26. In a second second charging step L2.2, a charging station time stamp 27 is further created on the basis of the charging station time of day 26. In a third second charging step L2.3, the charging station time stamp 27 is further transmitted to the digital electricity meter 3. In a fourth second charging step L2.4, the meter time of day 23 is subsequently adjusted in that the charging station time stamp 27 is set as a current value of the meter time of day 23. The first second charging step L2.1 is preferably carried out no later than a third predetermined tolerance time period after the first operating step B1. The fourth second charging step L2.4 is particularly preferably carried out no later than a second predetermined tolerance time period after the second second charging step L2.2. In particular, 5 seconds, preferably 4 seconds, preferably 3 seconds, preferably 2 seconds, preferably 1 second, particularly preferably 0.5 seconds, is used as the second predetermined tolerance time period and/or the third predetermined tolerance time period.

The fourth second charging step L2.4 is in particular carried out no later than a first predetermined tolerance time period after the first operating step B1. In particular, 5 seconds, preferably 4 seconds, preferably 3 seconds, preferably 2 seconds, preferably 1 second, particularly preferably 0.5 seconds, is used as the first predetermined tolerance time period. The first tolerance time period is thus in particular at least as long as the sum of the second tolerance time period and the third tolerance time period.

In the first operating step B1 or in the second charging step L2, in particular in the first second charging step L2.1, the encrypted, that is, in particular signed digital time stamp 21 is preferably decrypted. In addition, the signature of the signed digital time stamp is preferably verified in the first operating step B1 or in the second charging step L2, in particular in the first second charging step L2.1. In addition, the charging station time stamp 27 is preferably transmitted to the digital electricity meter in an unencrypted manner.

In a third charging step L3, an energy transfer to an electric vehicle is carried out. The second charging step L2 is preferably carried out at a time prior to the third charging step L3. Alternatively or additionally, the third charging step L3, in particular the energy transfer, is only activated when the second charging step L2 has been performed.

In a fourth charging step L4, a charging process data set 25 is created by using the meter time of day 23—in particular by the digital electricity meter 3.

The charging process data set 25 is preferably digitally signed by the digital electricity meter 3.

The charging process data set 25 preferably comprises at least one piece of information, which is selected from a group, consisting of: The unique user identification 31, an amount of energy released by the charging station 1, in particular transferred to the electric vehicle, a start time and a time period of the charging process, the start time and an end time of the charging process, a unique electricity meter identification of the digital electricity meter 3, and a combination of at least two pieces of this information. The charging process data set 25 is particularly preferably created as OCMF file.

In a fifth charging step L5, the charging process is ended.

In an optional sixth charging step L6, the charging process data set 25 is preferably transmitted to the charging station data center 17. In addition, the charging process data set 25 is particularly preferably stored in the charging station data center 17.

FIG. 4 shows a flowchart of a second exemplary embodiment of the method for operating the charging station 1.

In a third operating step B3, the charging station 1 is turned on.

In a fourth operating step B4, a startup process is carried out, in particular at a time period immediately after the third operating step B3.

During the fourth operating step B4, the first operating step B1 according to FIG. 3 is carried out, and the current time of day is received by the charging station 1 as the digital time stamp 21.

In a startup step S, the meter time of day 23 is adjusted based on the digital time stamp 21.

In a first startup step S1, the charging station time of day 26 is preferably adjusted on the basis of the digital time stamp 21, in particular in that the digital time stamp 21 is set as a current value of the charging station time of day 26. In a second startup step S2, the charging station time stamp 27 is further created on the basis of the charging station time of day 26. In a third startup step S3, the charging station time stamp 27 is furthermore transmitted to the digital electricity meter 3. In a fourth startup step S4, the meter time of day 23 is subsequently adjusted in that the charging station time stamp 27 is set as a current value of the meter time of day 23. The first startup step S1 is preferably carried out no later than the third predetermined tolerance time period after the first operating step B1. The fourth startup step S4 is particularly preferably carried out no later than the second predetermined tolerance time period after the second startup step S2. In particular, 5 seconds, preferably 4 seconds, preferably 3 seconds, preferably 2 seconds, preferably 1 second, particularly preferably 0.5 seconds, is used as the second predetermined tolerance time period and/or the third tolerance time period.

The fourth operating step S4 is in particular carried out no later than the first predetermined tolerance time period after the first operating step B1. In particular, 5 seconds, preferably 4 seconds, preferably 3 seconds, preferably 2 seconds, preferably 1 second, particularly preferably 0.5 seconds, is used as the first predetermined tolerance time period. The first tolerance time period is thus in particular at least as long as the sum of the second tolerance time period and the third tolerance time period.

Following the startup step S, the charging process can be carried out as the second operating step B2 according to FIG. 3.

FIG. 5 shows a flowchart of a third exemplary embodiment of the method for operating the charging station 1.

In a fifth operating step B5, in particular at a time before or after the second operating step B2 according to FIG. 3, an updating process is carried out.

During the fifth operating step B5, the first operating step B1 according to FIG. 3 is carried out and the current time of day is received by the charging station 1 as the digital time stamp 21.

In an updating step A, the meter time of day 23 is adjusted based on the digital time stamp 21.

In a first updating step A1, the charging station time of day 26 is preferably adjusted on the basis of the digital time stamp 21, in particular in that the digital time stamp 21 is set as a current value of the charging station time of day 26. In a second updating step A2, the charging station time stamp 27 is further created on the basis of the charging station time of day 26. In a third updating step A3, the charging station time stamp 27 is furthermore transmitted to the digital electricity meter 3. In a fourth updating step A4, the meter time of day 23 is adjusted subsequently in that the charging station time stamp 27 is set as a current value of the meter time of day 23. The first updating step A1 is preferably carried out no later than the third predetermined tolerance time period after the first operating step B1. The fourth updating step A4 is particularly preferably carried out no later than the second predetermined tolerance time period after the second updating step A2. In particular, 5 seconds, preferably 4 seconds, preferably 3 seconds, preferably 2 seconds, preferably 1 second, particularly preferably 0.5 seconds, is used as the second predetermined tolerance period and/or the third predetermined tolerance time period.

The fourth updating step $4 is in particular carried out no later than the first predetermined tolerance time period after the first operating step B1. In particular, 5 seconds, preferably 4 seconds, preferably 3 seconds, preferably 2 seconds, preferably 1 second, particularly preferably 0.5 seconds, is used as the first predetermined tolerance time period. The first tolerance time period is thus in particular at least as long as the sum of the second tolerance time period and the third tolerance time period.

The fifth operating step B5 is carried out when at least 24 hours, preferably at least 12 hours, preferably at least 10 hours, preferably at least 5 hours, preferably at least 2 hours, preferably at least 1 hour, have passed since a previous setting of the meter time of day 23. The fifth operating step B5 is thus in particular carried out when at least 24 hours, preferably at least 12 hours, preferably at least 10 hours, preferably at least 5 hours, preferably at least 2 hours, preferably at least 1 hour, have passed since an operating step was carried out last, selected from the second operating step B2, in particular the second charging step L2, the fourth operating step B4, in particular the startup step S, and the fifth operating step B5, in particular the updating step A.

FIG. 6 shows a flowchart of a fourth exemplary embodiment of the method for operating the charging station 1.

The third operating step B3 is thereby carried out first, and then the fourth operating step B4 according to FIG. 4.

Following the fourth operating step B4, either the fifth operating step B5 according to FIG. 5 or the second operating step B2 according to FIG. 3 is carried out optionally.

After the second operating step B2, the fifth operating step B5 is carried out optionally.

The fifth operating step B5 is in particular carried out when at least 24 hours, preferably at least 12 hours, preferably at least 10 hours, preferably at least 5 hours, preferably at least 2 hours, preferably at least 1 hour, have passed since an operating step was carried out last, selected from the second operating step B2, in particular the second charging step L2, the fourth operating step B4, in particular the startup step S, and the fifth operating step B5, in particular the updating step A.

1. A method for operating a charging station having a digital electricity meter for electric vehicles, whereby a current time of day is received by the charging station as a digital time stamp, whereby a charging process is carried out by means of the charging station, whereby
the charging process is initiated, whereby
after the initiation of the charging process, a meter time of day of the digital electricity meter is adjusted based on the digital time stamp, whereby
an energy transfer to an electric vehicle is carried out, whereby
a charging process data set is created by using the meter time of day, whereby
the charging process is ended.

2. The method according to claim 1, whereby, based on the digital time stamp, a charging station time stamp is created, whereby the charging station time stamp is transmitted to the digital electricity meter, whereby the meter time of day is adjusted in that the charging station time stamp is set as a current value of the meter time of day.

3. The method according to claim 1, whereby the charging process data set is digitally signed by the digital electricity meter.

4. The method according to claim 1, whereby at least one time of day, selected from the meter time of day and a charging station time of day, is adjusted no later than a predetermined tolerance time period after the receipt of the current time of day as the digital time stamp or after the creation of the charging station time stamp.

5. The method according to claim 1, whereby 5 seconds, preferably 4 seconds, preferably 3 seconds, preferably 2 seconds, preferably 1 second, particularly preferably 0.5 seconds, is used as the predetermined tolerance time period.

6. The method according to claim 1, whereby, based on the digital time stamp, the meter time of day of the digital electricity meter is adjusted before the energy transfer is started, and/or whereby the energy transfer is activated only when the meter time of day has been adjusted, based on the digital time stamp.

7. The method according to claim 1, whereby a user of the charging station is identified during the initiation of the charging process, whereby a unique user identification is detected, whereby the unique user identification is transmitted to the digital electricity meter.

8. The method according to claim 1, whereby a charging point of the charging station is selected, in particular by the user, in particular by means of an operating device, during the initiation of the charging process, in particular before the user of the charging station is identified.

9. The method according to claim 1, whereby a payment type is selected, in particular by a user, in particular by means of an operating device, during the initiation of the charging process, in particular before the user of the charging station is identified.

10. The method according to claim 1, whereby the user of the charging station is identified on the basis of
a) an RFID chip, and/or
b) a credit card, and/or
c) a smartphone, and/or
d) a charge card, and/or
e) a digital service recipient identification
during the initiation of the charging process.

11. The method according to claim 1, whereby the unique user identification is transmitted to a charging station data center during the initiation of the charging process, whereby the charging station data center releases the energy transfer at the charging station based on the unique user identification.

12. The method according to claim 1, whereby the charging process data set comprises at least one piece of information, which is selected from a group, consisting of: The unique user identification, an amount of energy released by the charging station, in particular transferred to the electric vehicle, a start time and a time period of the charging process, the start time and an end time of the charging process, a unique electricity meter identification of the digital electricity meter, and a combination of at least two pieces of this information, whereby the charging process data set is preferably created as an OCMF file.

13. The method according to claim 1, whereby the charging process data set is transmitted to the charging station data center, and whereby in particular the charging process data set is stored in the charging station data center.

14. The method according to claim 1, whereby
a startup process is carried out immediately after turning on the charging station, whereby
the current time of day is received by the charging station as the digital time stamp during the startup process, whereby
the meter time of day is adjusted based on the digital time stamp, whereby
the charging station time stamp is preferably created based on the digital time stamp, whereby the charging station time stamp is transmitted to the digital electricity meter, whereby the meter time of day is adjusted in that the charging station time stamp is set as a current value of the meter time of day.

15. The method according to claim 1, whereby
an updating process is carried out when at least 24 hours, preferably at least 12 hours, preferably at least 10 hours, preferably at least 5 hours, preferably at least 2 hours, preferably at least 1 hour, have passed since a previous adjustment of the meter time of day, whereby
the current time of day is received as the digital time stamp during the updating process by the charging station, whereby
the meter time of day is adjusted based on the digital time stamp, whereby
the charging station time stamp is preferably created based on the digital time stamp, whereby the charging station time stamp is transmitted to the digital electricity meter, whereby the meter time of day is adjusted in that the charging station time stamp is set as a current value of the meter time of day.

16. A charging station comprising a digital electricity meter, whereby the charging station is configured to be operated according to a method according to claim 1.
